(19) United States
(12) Patent Application Publication
(10) Pub. No.: US 2003/0098536 A1
(43) Pub. Date: May 29, 2003

(54) Hydraulic vibration isolating apparatus

(75) Inventor: Koichi Hasegawa, Kasugai-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKAI RUBBER INDUSTRIES, LTD., Komaki-shi (JP)

(21) Appl. No.: 10/267,691

(22) Filed: Oct. 10, 2002

(30) Foreign Application Priority Data
Nov. 27, 2001 (JP) 2001-361157

(51) Int. Cl. F16F 15/00

(52) U.S. Cl. 267/140.13

(57) ABSTRACT

A hydraulic vibration isolating apparatus includes a first installation member, a rubber elastic member, a second installation member, a diaphragm, and a partition member. The second installation member has a cylinder-shaped press-in wall, and an orifice forming wall. The orifice forming wall extends from one of the opposite ends of the press-in wall toward the inner peripheral side and then toward the partition member, and forms an orifice passage together with the press-in wall and the partition member. The orifice passage communicates a main liquid chamber with an auxiliary liquid chamber. The hydraulic vibration isolating apparatus can be manufactured with ease and at reduced costs.

### BACKGROUND OF THE INVENTION

1. Field of the Invention

The present invention relates to a hydraulic vibration isolating apparatus which can be properly used, for example, as engine mounts, cab mounts and the like for vehicles.

2. Description of the Related Art

In vehicles on which an engine making a vibration source is boarded, a supported member such as a power unit has been conventionally installed to a supporting member such as a body frame by way of an engine mount which supports the supported member in a vibration insulating manner. As for such an engine mount, hydraulic vibration insulating apparatuses illustrated in FIG. 3 and FIG. 4 have been known conventionally.

The conventional hydraulic vibration isolating apparatus illustrated in FIG. 3 comprises a first installation member 101, a rubber elastic member 102, a second installation member 103, a diaphragm 104 and a partition member 105. The first installation member 101 has a first bracket 110 which is fixed to one of installation mating members. The rubber elastic member 102 is attached to the first installation member 101 at one of the opposite ends, and has a dented portion 122 which is opened at the other one of the opposite ends. The second installation member 103 is attached to the outer periphery of the other opposite end of the rubber elastic member 102, and has a press-in wall 131 which is fitted into a second bracket 130 by pressing. The second bracket 130 is fixed to the other one of the installation mating members. The diaphragm 104 is held by the inner periphery of the second installation member 103 at the outer peripheral end, and forms a liquid chamber between itself and the dented portion 122 of the rubber elastic member 102, in liquid chamber which a liquid “L” is sealed. The partition member 105 is held by the inner periphery of the second installation member 103 at the outer peripheral end, demarcates the liquid chamber into a main liquid chamber 155 and an auxiliary liquid chamber 156, and has an orifice passage 157 which communicates the main liquid chamber 155 with the auxiliary liquid chamber 156 with each other.

Note that, in this conventional hydraulic vibration isolating apparatus, the orifice passage 157 is formed by two ring-shaped metallic plates 158 and 159 which make the partition member 105.

Moreover, the conventional hydraulic vibration isolating apparatus illustrated in FIG. 4 comprises a first installation member 201, a rubber elastic member 202, a second installation member 203, a diaphragm 204 and a partition member 205. The first installation member 201 has a first bracket 210 which is fixed to one of installation mating members. The rubber elastic member 202 is attached to the first installation member 201 at one of the opposite ends, and has a dented portion 222 which is opened at the other one of the opposite ends. The second installation member 203 has a cylinder-shaped body 232 which is attached to the outer periphery of the other opposite end of the rubber elastic member 202, and a press-in wall 231 which is disposed outside the cylinder-shaped body 232 and is fitted into the other one of the installation mating members by pressing. The diaphragm 204 is held by the inner periphery of the cylinder-shaped body 232 at the outer peripheral end, and forms a liquid chamber between itself and the dented portion 222 of the rubber elastic member 202, in liquid chamber which a liquid “L” is sealed. The partition member 205 is held by the inner periphery of a sealing rubber layer 234 at the outer periphery, demarcates the liquid chamber into a main liquid chamber 255 and an auxiliary liquid chamber 256, and forms an orifice passage 257 which communicates the main liquid chamber 255 with the auxiliary liquid chamber 256 with each other.

Note that, in this conventional hydraulic vibration isolating apparatus, the orifice passage 257 is formed by an annularly-shaped dented groove 258 and the inner periphery of the cylinder-shaped body 232. The annularly-shaped dented groove 258 is disposed in the outer periphery of the partition member 205. The inner periphery of the rubber elastic member 202 is disposed outside the partition member 205 so as to cover the opening of the dented groove 258.

These conventional hydraulic vibration isolating apparatuses are installed to vehicles in the following manner. The first installation members 101 and 201 are fixed to either one of an engine-side installation mating member and a body-side installation mating member by way of the first brackets 110 and 210. At the same time, the second installation member 103 is fixed to the other one of the installation mating members by way of the second bracket 130 which is fitted around the press-in wall 131 of the second installation member 103, or the second installation member 203 is fixed to the other one of them by directly pressing the press-in wall 231 of the second installation member 203 into the other one of them.

Thus, the elastic deformations of the rubber elastic members 102 and 202 effectively absorb the vibrations of high frequency range which the engines produce. On the other hand, the liquid pillar resonance action of the liquid “L,” flowing in the orifice passages 157 and 257 in accordance the volumetric variations of the main liquid chambers 155 and 255 and the auxiliary liquid chambers 156 and 256, effectively absorbs the vibrations of low frequency range which are generated by the shaking engines and the like.

In the conventional hydraulic vibration isolating apparatuses, the press-in walls 131 and 231 of the second installation members 103 and 203 are fixed to the other one of the installation mating members by fitting the second bracket 130 into the other one of them by pressing, or by directly pressing the press-in wall 231 into the other one of them. However, the orifice passages 157 and 257 are structured differently. Namely, in the conventional hydraulic vibration isolating apparatus illustrated in FIG. 3, the orifice passage 157 is formed by the two metallic plates 158 and 159 which make the partition member 105. On the other hand, in the conventional hydraulic vibration isolating apparatus illustrated in FIG. 4, the orifice passage 257 is formed by the inner periphery of the sealing rubber layer 234 and the annularly-shaped dented groove 258 of the partition member 205 by using a part of the cylinder-shaped body 232 of the second installation member 203 in which the sealing rubber layer 234 is disposed.

Accordingly, in the conventional hydraulic vibration isolating apparatus illustrated in FIG. 3, the number of the component parts which make the partition member 105 is increased so that the structure is complicated. Therefore, it is troublesome to manufacture the conventional hydraulic vibration isolating apparatus. Thus, the increased number of the component parts is one of the causes to push up the manufacturing costs.

On the other hand, in the conventional hydraulic vibration isolating apparatus illustrated in FIG. 4, it is required to carry out the following operations in order to secure the liquid-tightness of the orifice passage 257 which is formed by the inner periphery of the sealing rubber layer 234 and the annularly-shaped dented groove 258 of the partition member 205. The partition member 205 is fitted into the cylinder-shaped body 232, which is covered with the sealing rubber layer 234, by pressing to assemble. Alternatively, the cylinder-shaped body 232 is subjected to drawing after it is assembled with the partition member 205. Thus, the troublesome operation of fitting the partition member 205 into the cylinder-shaped body 232 by pressing, or the extra operation of drawing the cylinder-shaped body 232 should be carried out. Therefore, in this case as well-it is inevitable to push up the manufacturing costs.

### SUMMARY OF THE INVENTION

The present invention has been developed in view of the aforementioned circumstances. It is therefore an object of the present invention to provide a hydraulic vibration isolating apparatus which can be manufactured with ease and at reduced costs.

A hydraulic vibration isolating apparatus according to the present invention can achieve the aforementioned object, and comprises: a first installation member installed to one of installation mating members; a rubber elastic member attached to the first installation member at one of the opposite ends, and having a dented portion which is opened at the other one of the opposite ends; a second installation member attached to the outer periphery of the other opposite end of the rubber elastic member, and installed to the other one of the installation mating members by being fitted thereinto by pressing; a diaphragm held by the inner periphery of the second installation member at the outer peripheral end, and forming a liquid chamber between itself and the dented portion of the rubber elastic member, in liquid chamber which a liquid is sealed; and a partition member held by the inner periphery of the second installation member at the outer peripheral end, and demarcating the liquid chamber into a main liquid chamber and an auxiliary liquid chamber; the second installation member having a cylinder-shaped press-in wall fitted into the other one of the installation mating members, and an orifice forming wall extending from one of the opposite ends of the press-in wall toward the inner peripheral side and then toward the partition member and forming an orifice passage together with the press-in wall and the partition member, the orifice passage communicating the main liquid chamber with the auxiliary liquid chamber.

In the present hydraulic vibration isolating apparatus, the orifice passage is formed by the press-in wall and orifice forming wall of the second installation member and a part of the partition member. In this arrangement, since the orifice forming wall extends from one of the opposite ends of the press-in wall toward the inner peripheral side and then toward the partition member, the press-in wall and the orifice forming wall form an annularly dented portion which is opened at one of the axially opposite ends in the axial direction. Accordingly, the orifice passage is formed in such a state that the partition member covers the opening of the annularly dented portion. Consequently, when the partition member is simply attached onto the opening of the annularly dented portion which is formed in the second installation member, it is possible to ensure the liquid-tightness of the orifice passage. Thus, it is possible to obviate the tiresome operations, which have been carried out conventionally in order to secure the liquid-tightness of the orifice passage, such as fitting the partition member into the second installation member by pressing to assemble and subjecting the second installation member to drawing after assembling. Moreover, in the present hydraulic vibration isolating apparatus, it is possible to readily form the orifice forming wall integrally with the press-in wall by pressing and the like. Hence, it is possible to manufacture the present hydraulic vibration isolating apparatus with ease and at reduced manufacturing costs.

Thus, in accordance with the present hydraulic vibration isolating apparatus, the second installation member has the press-in wall and the orifice forming wall, and the press-in wall, the orifice forming wall and the partition member form the orifice passage. Therefore, the manufacturing can be readily carried out, and thereby the manufacturing costs can be reduced.

Moreover, in the present hydraulic vibration isolating apparatus, since the orifice passage is formed by using the press-in wall of the second installation member, the orifice passage is placed at a position substantially equivalent to that of the press-in wall in the axial direction. Accordingly, it is possible to dispose the diaphragm, the partition member and the auxiliary liquid chamber at positions in proximity to the press-in wall in the axial direction. Thus, it is possible to design the axial length (or height) of the present hydraulic vibration isolating apparatus smaller. Consequently, it is possible to downsize the present hydraulic vibration isolating apparatus.

In addition, in the present hydraulic vibration isolating apparatus, the press-in wall and the orifice forming wall can preferably cross to make a corner which is formed as a curved surface.

In accordance with the preferred arrangement, when the second installation member is installed to an installation hole of the other one of the installation mating members by fitting the second installation member into the installation hole by pressing, the corner, making the press-in leading end, is put into such a state that it contacts snugly with the opening of the installation hole. Accordingly, it is easy to start fitting the second installation member into the other one of the installation mating member by pressing. Consequently, it is possible to smoothly carry out the press-in operation.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure:

FIG. 1 is a cross sectional drawing of a hydraulic vibration isolating apparatus according to an example of the present invention taken along the axial direction, and is viewed in the direction of the arrow “1”-“1” of FIG. 2;

FIG. 2 is a cross sectional drawing of the hydraulic vibration isolating apparatus according to the example of the present invention taken along the axially perpendicular direction, and is viewed in the direction of the arrow “2”-“2” of FIG. 1;

FIG. 3 is a cross sectional drawing of a conventional hydraulic vibration isolating apparatus taken along the axial direction; and

FIG. 4 is a cross sectional drawing of another conventional hydraulic vibration isolating apparatus taken along the axial direction.

### DETAILED DESCRIPTION OF THE PREFERRED EMBODIMENT

Having generally described the present invention, a further understanding can be obtained by reference to the specific preferred embodiment which is provided herein for the purpose of illustration only and not intended to limit the scope of the appended claims.

### EXAMPLE

Hereinafter, an example of the present invention will be described in detail with reference to the drawings.

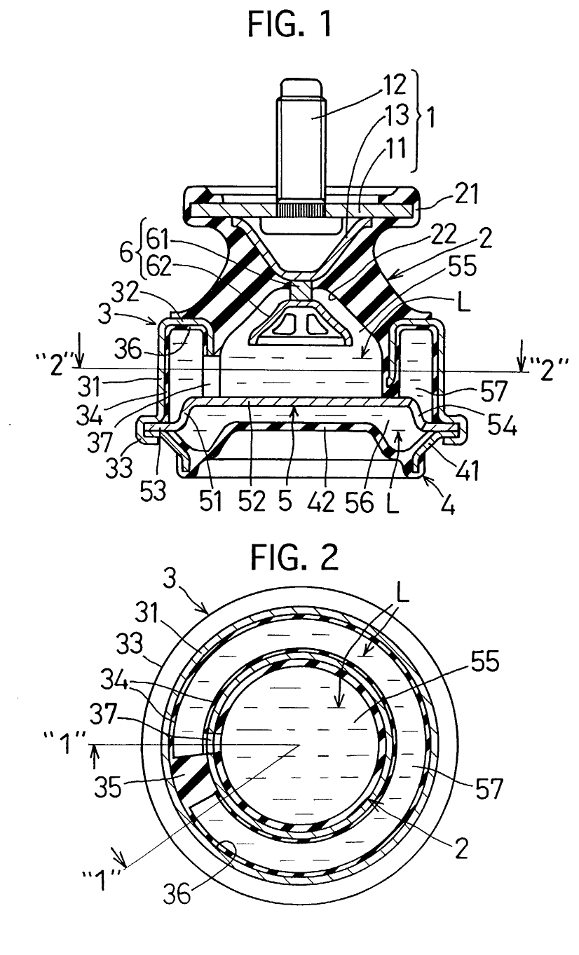

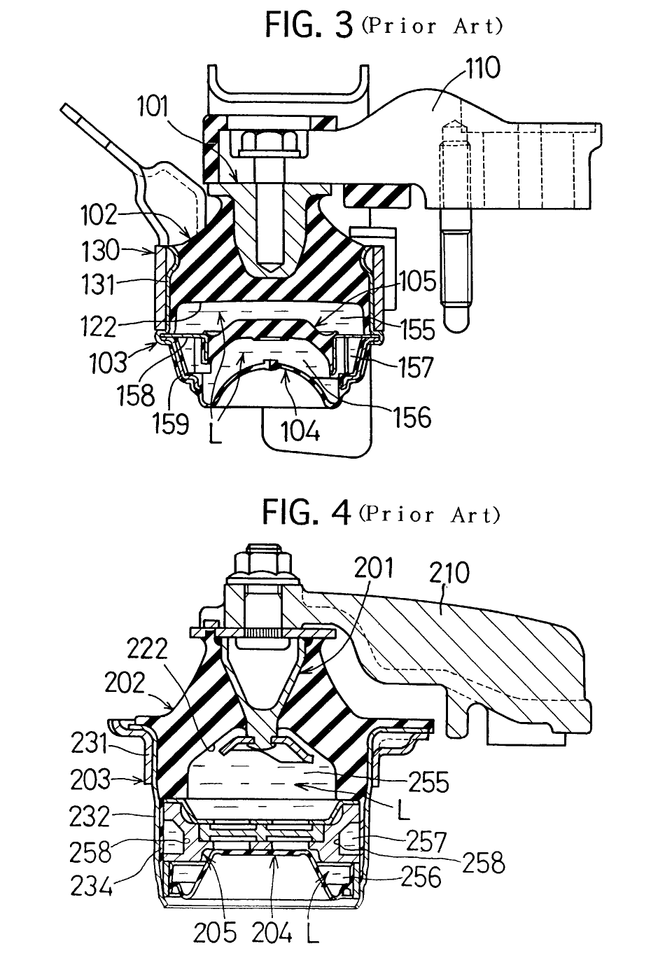

FIG. 1 is a cross sectional drawing of a hydraulic vibration isolating apparatus according to the example taken along the axial direction, and is viewed in the direction of the arrow “1”-“1” of FIG. 2. FIG. 2 is a cross sectional drawing of the hydraulic vibration isolating apparatus taken along the axially perpendicular direction, and is viewed in the direction of the arrow “2”-“2” of FIG. 1.

As illustrated in FIG. 1 and FIG. 2, the hydraulic vibration isolating apparatus according to the example comprises a first installation member 1, a rubber elastic member 2, a second installation member 3, a diaphragm 4, a partition member 5, and an umbrella-shaped member 6. The rubber elastic member 2 is attached to the first installation member 1 at one of the opposite ends, and has a dented portion 22 which is opened at the other one of the opposite ends. The second installation member 3 is attached to the outer periphery of the other opposite end of the rubber elastic member 2, and has a press-in wall 31 and an orifice forming wall 32. The diaphragm 4 is held by the inner periphery of the second installation member 3 at the outer peripheral end, and forms a liquid chamber between itself and the dented portion 22 of the rubber elastic member 2, in liquid chamber which a liquid “L” is sealed. The partition member 5 is held by the inner periphery of the second installation member 3 at the outer peripheral end, and demarcates the liquid chamber into a main liquid chamber 55 and an auxiliary liquid chamber 56. The umbrella-shaped member 6 is installed to the first installation member 1 so as to project into the main liquid chamber 55.

The first installation member 1 comprises a disk-shaped base plate 11, an installation bolt 12, and a supporter 13. The base plate 11 has a round hole at the center. The installation bolt 12 is engaged with and fixed in the round hole of the base plate 11 so as to project the threaded shank upward. The supporter 13 is formed of a metallic plate as a truncated cone shape, and is bonded by welding to the central portion of the lower surface of the base plate 11 at the major-diameter opening end.

The rubber elastic member 2 is formed of rubber as a substantially truncated cone shape. The rubber elastic member 2 is attached by vulcanization adhesion to the first installation member 1 in such a state that the supporter 13 of the first installation member 1 is buried in the central portion of the minor-diameter end. The rubber elastic member 2 is formed integrally with a cover 21 which covers the outer peripheral end of the base plate 11 of the first installation member 1. Moreover, the dented portion 22 is formed in the central portion of the major-diameter end of the rubber elastic member 2.

The second installation member 3 comprises the cylinder-shaped press-in wall 31, the orifice forming wall 32, and a crimped portion 33. The press-in wall 31 is fitted into one of installation mating members. The orifice forming wall 32 extends from one of the opposite ends of the press-in wall 31 (i.e., the upper end of the press-in wall 31 in FIG. 1) toward the inner peripheral side and then bent downward toward the partition member 5, and is formed as a ring shape whose cross section is a letter L shape. The crimped portion 33 is disposed continuously from the other opposite ends of the press-in wall 31 (i.e., the lower end of the press-in wall 31 in FIG. 1), and is formed as a ring shape whose cross section is a letter U shape. This second installation member 3 is formed integrally by processing a one-piece ferrous metallic plate. Note that, when the orifice forming wall 32 is formed by bending, the corner at which the press-in wall 31 and the orifice forming wall 32 cross is formed as a rounded curved surface.

The press-in wall 31 and the orifice forming wall 32 of the second installation member 3 form a letter U shape cross section which opens to the axially lower-end side in FIG. 1. Accordingly, there is formed an annularly-dented portion (or annularly-shaped trough) whose cross section is a letter U shape inside the press-in wall 31 and the orifice forming wall 32 of the second installation member 3. The inner surfaces of the press-in wall 31 and orifice forming wall 32 are covered with a sealing rubber layer 34 (or membrane) which is formed integrally with and connected to the rubber elastic member 2. Moreover, the annularly-dented portion, formed inside the upper portion of the press-in wall 31 and the orifice passage forming wall 32, is blocked by a partition wall 35 at a predetermined position in the peripheral direction as illustrated in FIG. 2. Note that the partition wall 35 is formed integrally with the sealing rubber layer 34. Thus, as illustrated in FIG. 2, a letter C shape orifice groove 36 is formed. In addition, as illustrated in FIG. 2, at a predetermined position of the orifice forming wall 32 which corresponds to the beginning end of the orifice groove 36, a communication hole 37 is formed which communicates the orifice groove 36 with the inner space (i.e., main liquid chamber 55) of the second installation member 3.

The outer peripheral surface of the orifice forming wall 32 is attached to the major-diameter end of the rubber elastic member 2 by vulcanization adhesion. Thus, the second installation member 3 is disposed coaxially with the first installation member 1 and the rubber elastic member 2. Moreover, as illustrated in FIG. 1, the outer peripheral end of a ring-shaped holding portion 41 of the diaphragm 4 and the outer peripheral end of a flange 53 of the partition member 5, which will be described later, are held in a crimped portion 33 of the second installation member 3, and fixed in a laminated manner by crimping.

The diaphragm 4 comprises the ring-shaped holding portion 41, and a rubber membrane 42 which are formed as a dome shape and attached to the holding portion 41 by vulcanization adhesion at the outer peripheral end. The outer peripheral end of the holding portion 41 is laminated on the flange 53 of the partition member 5, and is fixed together with the flange 53 in the crimped portion 33 of the second installation member 33 in a liquid-proof manner by crimping. Thus, a liquid-tight liquid chamber is formed between the diaphragm 4 and the dented portion 22 of the rubber elastic member 2. In the liquid chamber, an incompressible liquid “L,” for example, water, alkylene glycol, silicone oil and the like, is sealed.

The partition member 5 is formed of a metallic plate as a hat shape, and comprises a short cylinder portion 51, a ceiling portion 52 and the ring-shaped flange 53. The ceiling portion 52 encloses the opening at one of the opposite ends of the cylinder portion 51. The flange 53 extends from the other one of the opposite ends of the cylinder portion 51 outward in the radial direction. Moreover, as illustrated in FIG. 1, at a predetermined position of the cylinder portion 51 which corresponds to the terminating end of the orifice groove 36, a communication hole 54 is formed which communicates the inside of the cylinder portion 51 with the outside thereof (i.e., the auxiliary liquid chamber 56 with the orifice passage 57).

The flange 53 of the partition member 5 is laminated on the outer peripheral end of the holding portion 41 of the diaphragm 4, and is fixed together with the outer peripheral end of the holding portion 41 in the crimped portion 33 of the second installation member 3 in a liquid-proof manner by crimping. Thus, the partition member 5 demarcates the liquid chamber into the main liquid chamber 55, formed on the side of the rubber elastic member 2, and the auxiliary liquid chamber 56, formed on the side of the diaphragm 4. Moreover, as illustrated in FIG. 1, when the flange 53 of the partition member 5 is fixed in the crimped portion 33 by crimping, the sealing rubber layer 34, which is disposed at the axially-extension leading end (i.e., lower end) of the orifice forming wall 32, is pressed onto the ceiling portion 52. Accordingly, the opening of the orifice groove 36 is covered with the partition member 5 in a liquid-proof manner. Thus, an orifice passage 57 is formed. The orifice passage 57 communicates the main liquid chamber 55 with the auxiliary liquid chamber 56 by way of the orifice groove 36 and the communication holes 37 and 54 which are formed at the opposite ends of the orifice groove 36.

The umbrella-shaped member 6 comprises a shank-shaped supporting portion 61, and a dome-shaped umbrella fitting 62. The trailing end of the supporting portion 61 is bonded by welding to the central portion of the lower surface of the base plate 11 of the first installation member 1, and the leading end is projected into the main liquid chamber 55. The umbrella fitting 62 is attached to the leading end of the supporting portion 61, and is disposed in the main liquid chamber 55. Accordingly, the umbrella fitting 62 forms a narrowed passage between its own outer peripheral surface and the surface of the dented portion 22 of the rubber elastic member 2 which faces the outer peripheral surface. Thus, the umbrella-shaped member 6 reduces the vibrations of high frequency range by the liquid pillar resonance action of the liquid “L,” flowing in the narrowed passage when the vibrations are input.

The thus constructed hydraulic vibration isolating apparatus of the example is used as an engine mount for a vehicle, and is installed to a vehicle in the following manner, for instance. With respect to either one of an engine-side installation mating member and a body-side installation mating member, the first installation member 1 is fixed by way of a bracket by fastening the installation bolt 12 to the bracket with a nut. At the same time, with respect to an installation hole, formed in the other one of the engine-side installation mating member and the body-side installation mating member, or to an installation hole of the other bracket, disposed on the other one of them, the second installation member 3 is fixed by fitting the press-in wall 31 into the installation hole by pressing.

When vibrations, produced by an engine, are input into the hydraulic vibration isolating apparatus of the example, the vibrations of high frequency range are absorbed effectively by the elastic deformations of the rubber elastic member 2 and the liquid pillar resonance action of the liquid “L,” flowing in the narrowed passage within the main liquid chamber 55. On the other hand, the vibrations of low frequency range, generated by the shaking engine and the like, are absorbed effectively by the liquid pillar resonance action of the liquid “L,” flowing in the orifice passage 57 in accordance the volumetric variations of the main liquid chamber 55 and the auxiliary liquid chamber 57.

As described above, in the hydraulic vibration isolating apparatus of the example, the second installation member 2 has the cylinder-shaped press-in wall 31, and the orifice forming wall 32 which extends from the upper end of the press-in wall 31 toward the inner peripheral side and then toward the partition member 5 and forms the orifice passage 57 together with the press-in wall 31 and the partition member 5. Thus, it is possible to sufficiently secure the liquid-tightness of the orifice passage 57 which is formed by the press-in wall 31, the orifice forming wall 32 and the partition member 5. Accordingly, it is not necessary to carry out such troublesome operations as assembling the partition member 5 with the second installation member 3 by fitting the partition member 5 into the second installation member 3 by pressing and subjecting the second installation member 3 to drawing after assembling. Moreover, it is possible to readily form the orifice forming wall 32 integrally with the press-in wall 31 by pressing and the like.

Hence, it is possible to manufacture the hydraulic vibration isolating apparatus of the example with ease, and accordingly it is possible to reduce the manufacturing costs.

Moreover, in the hydraulic vibration isolating apparatus of the example, the orifice passage 57 is formed by using the press-in wall 31 of the second installation member 31, the orifice passage 57 is placed at a position substantially equivalent to that of the press-in wall 31 in the axial direction. Accordingly, it is possible to dispose the diaphragm 4, the auxiliary liquid chamber 56 and the partition member 5 at positions in proximity to the press-in wall 31 in the axial direction. Thus, it is possible to design the axial length (or height) of the hydraulic vibration isolating apparatus smaller. Consequently, it is possible to downsize the hydraulic vibration isolating apparatus.

In addition, in the hydraulic vibration isolating apparatus of the example, since the corner at which the press-in wall 31 and the orifice forming wall 32 cross is formed as a rounded curved surface, the corner, making the press-in leading end, is put into such a state that it contacts snugly with the opening of the installation hole when the second installation member 3 is installed to the other one of the engine-side installation mating member and the body-side installation mating member by fitting the second installation member 3 into the installation hole by pressing. Accordingly, it is easy to start fitting the second installation member 3 into the installation hole by pressing. Consequently, it is possible to smoothly carry out the press-in operation.

Having now fully described the present invention, it will be apparent to one of ordinary skill in the art that many changes and modifications can be made thereto without departing from the spirit or scope of the present invention as set forth herein including the appended claims.

What is claimed is:

1. A hydraulic vibration isolating apparatus, comprising:
a first installation member installed to one of installation mating members;
a rubber elastic member attached to said first installation member at one of the opposite ends, and having a dented portion which is opened at the other one of the opposite ends;
a second installation member attached to the outer periphery of the other opposite end of said rubber elastic member, and installed to the other one of the installation mating members by being fitted thereinto by pressing;
a diaphragm held by the inner periphery of said second installation member at the outer peripheral end, and forming a liquid chamber between itself and the dented portion of said rubber elastic member, in liquid chamber which a liquid is sealed; and
a partition member held by the inner periphery of said second installation member at the outer peripheral end, and demarcating the liquid chamber into a main liquid chamber and an auxiliary liquid chamber;
said second installation member having a cylinder-shaped press-in wall fitted into the other one of the installation mating members, and an orifice forming wall extending from one of the opposite ends of the press-in wall toward the inner peripheral side and then toward said partition member and forming an orifice passage together with the press-in wall and said partition member, the orifice passage communicating the main liquid chamber with the auxiliary liquid chamber.

2. The hydraulic vibration isolating apparatus set forth in claim 1, wherein the press-in wall and the orifice forming wall cross to make a corner which is formed as a curved surface.

3. The hydraulic vibration isolating apparatus set forth in claim 1, wherein the orifice passage is disposed around the main liquid chamber and above said partition member.

4. The hydraulic vibration isolating apparatus set forth in claim 1, wherein said second installation member and said partition member are assembled free of pressing.

5. The hydraulic vibration isolating apparatus set forth in claim 1, wherein said partition member and said diaphragm are held in said second installation in a laminated manner by crimping said second installation member.

6. The hydraulic vibration isolating apparatus set forth in claim 1, wherein the inner surface of the press-in wall and orifice forming wall of said second installation member is covered with a rubber membrane which is formed integrally with said rubber elastic member.

7. The hydraulic vibration isolating apparatus set forth in claim 6, wherein the rubber membrane is formed as an annularly-shaped trough whose cross section is inverted letter U shape, being opened at one of the axial opposite ends, is brought into contact with said partition member, and is interposed between the orifice forming wall and said partition member.

8. The hydraulic vibration isolating apparatus set forth in claim 7, wherein said annularly-shaped trough is blocked by a partition wall, being formed integrally with the rubber elastic member, at a predetermined position in the peripheral direction.

9. The hydraulic vibration isolating apparatus set forth in claim 1, wherein the orifice forming wall of said second installation member is cut off at a predetermined in the peripheral direction, thereby forming a communication hole communicating the orifice passage with the main liquid chamber; and said partition member is cut off at an offset position with respect to the predetermined position in the peripheral direction, thereby forming a communication hole communicating the orifice passage with the auxiliary liquid chamber.

10. The hydraulic vibration isolating apparatus set forth in claim 1, wherein said second installation member is formed of a one-piece workpiece.
